(19) United States
(12) Patent Application Publication
(10) Pub. No.: US 2002/0154635 A1
(43) Pub. Date: Oct. 24, 2002

(54) System and method for extending private networks onto public infrastructure using supernets

(75) Inventor: Yuefeng Liu, Stanford, CA (US)

Correspondence Address: FINNEGAN, HENDERSON, FARABOW, GARRETT &, DUNNER LLP, 1300 I STREET, NW, WASHINGTON, DC, 20005, US

(73) Assignee: Sun Microsystems, Inc.

(21) Appl. No.: 09/839,300

(22) Filed: Apr. 23, 2001

(51) Int. Cl. H04L 12/28

(52) U.S. Cl. 370/392; 370/400

(57) ABSTRACT

Methods and systems for enabling communications between a first private network and a second private network configured from nodes in a public network. When communicating a packet from the first private network to the second private network, a computer receives a packet from a source node in the first private network. The computer then determines whether the packet is destined for the second private network. Thereafter, if the packet is destined for the second private network, the computer forwards the packet to a destination node in the second private network. When communicating a packet from the second private network to the first private network, a computer receives a packet from a source node in the second private network. The computer then determines whether the packet is destined for the second private network. Thereafter, if the packet is not destined for the second private network, the computer forwards the packet to a destination node in the first private network.

### RELATED APPLICATIONS

The following identified U.S. patent applications are relied upon and are incorporated by reference in this application.

U.S. patent application Ser. No. 09/458,043, entitled “SYSTEM AND METHOD FOR SEPARATING ADDRESSES FROM THE DELIVERY SCHEME IN A VIRTUAL PRIVATE NETWORK,” filed Dec. 10, 1999.

U.S. patent application Ser. No. 09/457,917, entitled “TRULY ANONYMOUS COMMUNICATIONS USING SUPERNETS WITH THE PROVISION OF TOPOLOGY HIDING,” filed Dec. 10, 1999.

U.S. patent application Ser. No. 09/457,889, entitled “METHOD AND SYSTEM FOR FACILITATING RELOCATION OF DEVICES ON A NETWORK,” filed Dec. 10, 1999.

U.S. patent application Ser. No. 09/457,916, entitled “SANDBOXING APPLICATIONS IN A PRIVATE NETWORK USING A PUBLIC-NETWORK INFRASTRUCTURE,” filed Dec. 10, 1999.

U.S. patent application Ser. No. 09/457,894, entitled “SECURE ADDRESS RESOLUTION FOR A PRIVATE NETWORK USING A PUBLIC-NETWORK INFRASTRUCTURE,” filed Dec. 10, 1999.

U.S. patent application Ser. No. 09/458,020, entitled “DECOUPLING ACCESS CONTROL FROM KEY MANAGEMENT IN A NETWORK,” filed Dec. 10, 1999.

U.S. patent application Ser. No. 09/457,895, entitled “CHANNEL-SPECIFIC FILE SYSTEM VIEWS IN A PRIVATE NETWORK USING A PUBLIC NETWORK INFRASTRUCTURE,” filed Dec. 10, 1999.

U.S. patent application Ser. No. 09/458,040, entitled “PRIVATE NETWORK USING A PUBLIC-NETWORK INFRASTRUCTURE,” filed Dec. 10, 1999.

U.S. patent application Ser. No. 09/457,914, entitled “SYSTEM AND METHOD FOR ENABLING SCALABLE SECURITY IN A VIRTUAL PRIVATE NETWORK,” filed Dec. 10, 1999.

U.S. patent application Ser. No. 09/457,915, entitled “USING MULTICASTING TO PROVIDE ETHERNET-LIKE COMMUNICATION BEHAVIOR TO SELECTED PEERS ON A NETWORK,” filed Dec. 10, 1999.

U.S. patent application Ser. No. 09/457,896, entitled “ANYCASTING IN A PRIVATE NETWORK USING A PUBLIC NETWORK INFRASTRUCTURE,” filed Dec. 10, 1999.

U.S. patent application Ser. No. 09/458,021, entitled “SCALABLE SECURITY ASSOCIATIONS FOR GROUPS FOR USE IN A PRIVATE NETWORK USING A PUBLIC-NETWORK INFRASTRUCTURE,” filed Dec. 10, 1999.

U.S. patent application Ser. No. 09/458,044, entitled “ENABLING SIMULTANEOUS PROVISION OF INFRASTRUCTURE SERVICES,” filed Dec. 10, 1999.

### FIELD OF THE INVENTION

The present invention relates generally to data processing systems and, more particularly, to extending private networks onto public infrastructure.

### BACKGROUND AND MATERIAL INFORMATION

As part of their day-to-day business, many organizations require an enterprise network, a private network with lease lines, dedicated channels, and network connectivity devices, such as routers, switches, and bridges. These components, collectively known as the network's “infrastructure,” are very expensive and require a staff of information technology personnel to maintain them. This maintenance requirement is burdensome on many organizations whose main business is not related to the data processing industry (e.g., a clothing manufacturer) because they are not well suited to handle such data processing needs.

Another drawback to enterprise networks is that they are geographically restrictive. The term “geographically restrictive” refers to the requirement that if a user is not physically located such that they can plug their device directly into the enterprise network, the user cannot typically utilize it. To alleviate the problem of geographic restrictiveness, virtual private networks have been developed.

In a virtual private network (VPN), a remote device or network connected to the Internet may connect to the enterprise network through a security mechanism such as a firewall. This allows the remote device to access resources on the enterprise network even though it may not be located near any component of the enterprise network. To perform this functionality, a remote device may utilize a technique known as tunneling to ensure that the communication between itself and the enterprise network is secure in that it cannot be viewed by an interloper.

“Tunneling” refers to encapsulating one packet inside another when packets are transferred between end points. The packets may be encrypted at their origin and decrypted at their destination. The tunneling technique forms a new packet out of an original packet by encrypting it and adding both a new source IP (Internet Protocol) address and a new destination IP address. In this manner, the contents of the original packet are not visible to any entity other than the destination.

Although VPNs alleviate the problem of geographic restrictiveness, they impose significant processing overhead when two remote devices communicate. Given this processing overhead, it is burdensome for two remote devices to communicate in a VPN environment. To alleviate the need of organizations to maintain their own network infrastructure, as well as to improve communication between remote devices, a “Supernet” may be utilized. A Supernet is a private network that uses components from a public-network infrastructure. A Supernet allows an organization to utilize a public-network infrastructure for its enterprise network so that the organization no longer has to maintain a private network infrastructure; instead, the organization may have the infrastructure maintained for them by one or more service providers or other organizations that specialize in such connectivity matters. As such, the burden of maintaining an enterprise network is greatly reduced. Moreover, a Supernet is not geographically restrictive, so a user may plug their device into the Internet from virtually any portal in the world and still be able to use the resources of their private network in a secure and robust manner.

A Supernet, however, requires all computers of a private network to be on the public infrastructure. Many organizations have pre-existing private networks that are not on the public infrastructure. Switching all of the computers of such a network to the public infrastructure may be prohibitively time consuming and expensive. Accordingly, there is a need for a system and method for connecting a pre-existing private network to a private network, such as a Supernet, built on top of public infrastructure.

### SUMMARY OF THE INVENTION

Methods and systems consistent with the principles of the invention enable communications between a first private network and a second private network configured from nodes in a public network. A computer receives a packet from a source node in the first private network. The computer then determines whether the packet is destined for the second private network. Thereafter, if the packet is destined for the second private network that uses the public network infrastructure, the computer forwards the packet to a destination node in the second private network.

Other methods and systems consistent with the principles of the invention enable communications between a first private network and a second private network configured from nodes in a public network. A computer receives a packet from a source node in the second private network. The computer then determines whether the packet is destined for the second private network. Thereafter, if the packet is not destined for the second private network that uses the public network infrastructure, the computer forwards the packet to a destination node in the first private network.

Other methods and systems consistent with the principles of the invention also enable communications between a first private network and a second private network configured from nodes in a public network. A computer receives a packet from a source node in the first private network. The computer then determines whether the packet is destined for the second private network. Based on the determination, the computer obtains an address mapping corresponding to a destination node in the second private network. Thereafter, the computer sends the packet to the destination node using the address mapping, the address mapping reflecting a relationship between an internal address for the destination node for use in communicating among nodes in the second private network and an external address for the destination node suitable for communicating over the public infrastructure.

Other methods and systems consistent with the principles of the invention also enable communications between a first private network and a second private network configured from nodes in a public network. A computer receives a packet from a source node in the second private network. The computer then determines whether the packet is destined for the second private network. Based on the determination, the computer obtains an address mapping corresponding to a router node based on the determination. Thereafter, the computer sends the packet to the router node using the address mapping. The router node forwards the packet to a destination node in the first private network based on an internal address in the packet for the destination node suitable for communicating among nodes in the first private network.

### BRIEF DESCRIPTION OF THE DRAWINGS

The accompanying drawings are incorporated in and constitute a part of this specification and, together with the description, explain the features and principles of the invention. In the drawings:

FIG. 1 is a diagram of an exemplary network environment in which a Supernet may be implemented;

FIG. 2 is a diagram of the nodes depicted in FIG. 1 communicating over multiple channels;

FIG. 3 is a diagram of an exemplary network environment in which the features and aspects of the present invention may be implemented;

FIG. 4A is a diagram of an administrative machine in which the features and aspects of the present invention may be implemented;

FIG. 4B is an address mapping record for use with methods and systems consistent with the present invention;

FIG. 5 is a diagram of a device with a Supernet node in which the features and aspects of the present invention may be implemented;

FIG. 6 is a diagram of a device with a router node in which the features and aspects of the present invention may be implemented;

FIG. 7 is an exemplary flowchart of a method for sending a packet from an enterprise network to a Supernet in a manner consistent with the present invention;

FIG. 8 is an exemplary flowchart of a method for receiving a packet by a Supernet node in a manner consistent with the present invention;

FIG. 9 is an exemplary flowchart of a method for sending a packet from a Supernet to an enterprise network in a manner consistent with the present invention; and

FIG. 10 is an exemplary flowchart of a method for receiving a packet for forwarding to an enterprise network in a manner consistent with the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the principles of the invention enable communications between a first private network and a second private network configured from nodes in a public network. When communicating a packet from the first private network to the second private network, a computer receives a packet from a source node in the first private network. The computer then determines from data in the packet whether the packet is destined for the second private network. Based on the determination, the computer obtains an address mapping corresponding to a destination node in the second private network. Thereafter, the computer sends the packet to the destination node using the address mapping. The address mapping reflects a relationship between an internal address for the destination node for use in communicating among nodes in the second private network and an external address for the destination node suitable for communicating over the public network.

When communicating a packet from the second private network to the first private network, a computer receives a packet from a source node in the second private network. The computer then determines whether the packet is destined for the second private network. Based on the determination, the computer obtains an address mapping corresponding to a router node based on the determination. Thereafter, the computer sends the packet to the router node using the address mapping. The router node forwards the packet to a destination node in the first private network based on an internal address in the packet for the destination node suitable for communicating among nodes in the first private network.

### Network Environment

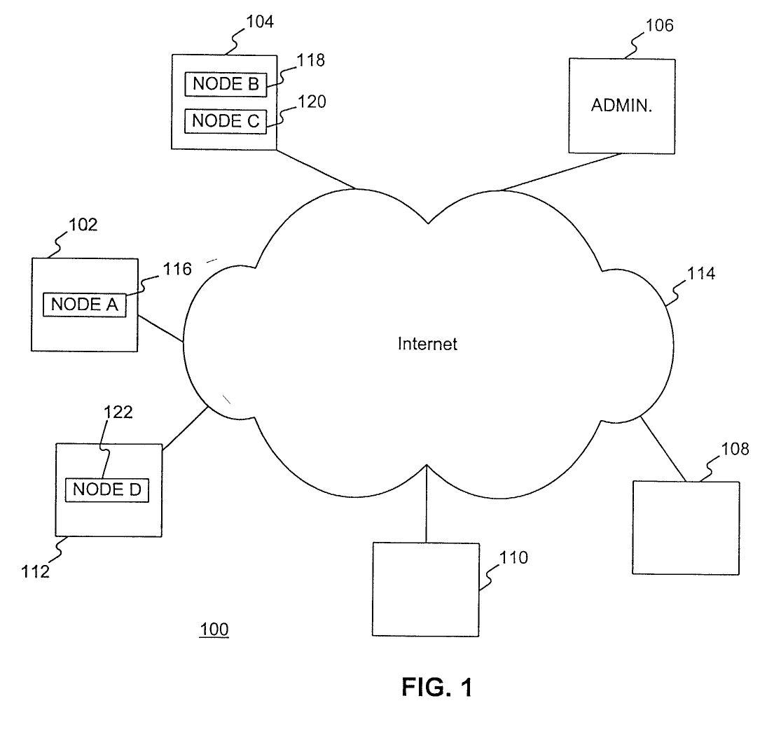

FIG. 1 is a diagram of an exemplary network environment in which a Supernet may be implemented. Network environment 100 comprises a number of devices, such as computers 102-112 (including administrative machine 106), connected to a public network, such as Internet 114. A Supernet's infrastructure uses components from the Internet because devices 102, 104, and 112 contain nodes that together form a Supernet and that communicate by using the infrastructure of the Internet. These nodes 116, 118, 120, and 122 are communicative entities (e.g., processes) running within a particular device and are able to communicate among themselves as well as access the resources of the Supernet in a secure manner. When communicating among themselves, the nodes 116, 118, 120, and 122 serve as end points for the communications, and no other processes or devices that are not part of the Supernet are able to communicate with the Supernet's nodes or utilize the Supernet's resources. The Supernet also includes an administrative node 106 to administer to the resources of the Supernet.

Since the nodes of the Supernet rely on a public network such as the Internet for connectivity, if the device on which a node is running relocates to another geographic location, the device can be plugged into an Internet portal and the node running on that device can quickly resume the use of the resources of the Supernet. Also, since a Supernet is layered on top of an existing network, it operates independently of the transport layer. Thus, the nodes of a Supernet may communicate over different transports, such as IP (Internet Protocol), IPX (Internetwork Packet Exchange), X.25, or ATM (Asynchronous Transfer Mode), as well as different physical layers, such as RF (Radio Frequency) communication, cellular communication, satellite links, or land-based links.

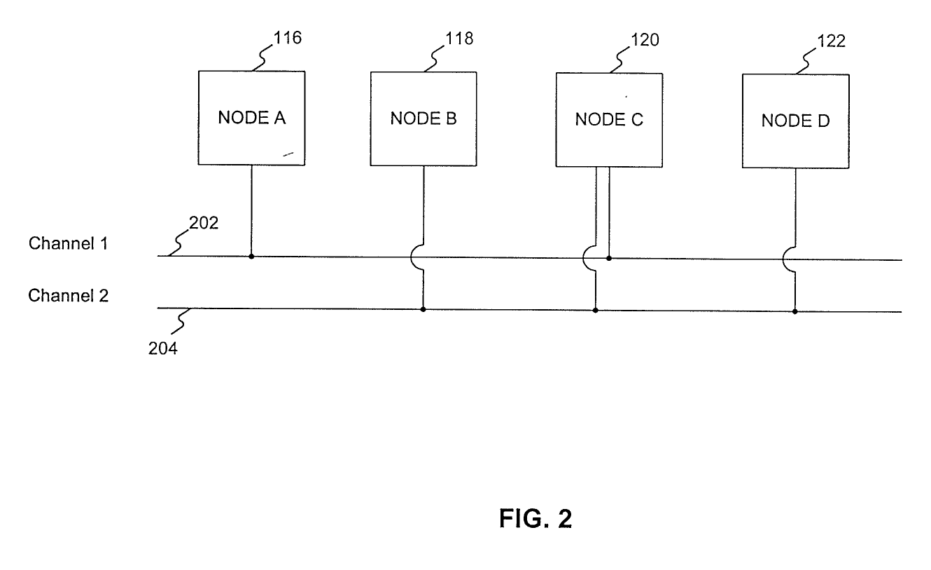

As shown in FIG. 2, a Supernet includes a number of channels over which its nodes 116-122 communicate. A “channel” refers to a collection of virtual links through the public-network infrastructure that connect the nodes on the channel such that only these nodes can communicate over it. A node on a channel may send a message to another node on that channel, known as a unicast message, or it can send a message to all other nodes on that channel, known as a multicast message. For example, channel 1 202 connects node A 116 and node C 120, and channel 2 204 connects node B 118, node C 120, and node D 122. Each Supernet has any number of preconfigured channels over which nodes can communicate. In an alternative embodiment, the channels are dynamically defined.

In addition to communication, the channels may be used to share resources. For example, channel 1 202 may be configured to share a file system as part of node C 120 such that node A 116 can utilize the file system of node C in a secure manner. In this case, node C 120 serves as a file system manager by receiving file system requests (e.g., open, close, read, write, etc.) and satisfying the requests by manipulating a portion of the secondary storage on its local machine.

To maintain security, node C 120 stores the data in an encrypted form so that it is unreadable by others. Such security is important because the secondary storage may not be under the control of the owners of the Supernet, but may instead be leased from a service provider. Additionally, channel 2 204 may be configured to share the computing resources of node D 122 such that nodes B 118 and C 120 send program code to node D for execution. By using channels in this manner, resources on a public network can be shared in a secure manner.

A Supernet provides a number of features to ensure secure and robust communication among its nodes. First, the system provides authentication and admission control so that nodes become members of the Supernet under strict control to prevent unauthorized access. Second, the Supernet provides communication security services so that the sender of a message is authenticated and communication between end points occurs in a secure manner by using encryption. Third, the system provides key management to reduce the possibility of an intruder obtaining an encryption key and penetrating a secure communication session. The system does so by providing one key per channel and by changing the key for a channel whenever a node joins or leaves the channel. Alternatively, the system may use a different security policy.

Fourth, the system provides address translation in a transparent manner. Since the Supernet is a private network constructed from the infrastructure of another network, the Supernet has its own internal addressing scheme, separate from the addressing scheme of the underlying public network. Thus, when a packet from a Supernet node is sent to another Supernet node, it travels through the public network. To do so, the Supernet performs address translation from the internal addressing scheme to the public addressing scheme and vice versa. To reduce the complexity of Supernet nodes, system-level components of the Supernet perform this translation on behalf of the individual nodes so that it is transparent to the nodes. Another benefit of the Supernet's addressing is that it uses an IP-based internal addressing scheme so that preexisting programs require little modification to run within a Supernet.

Lastly, the Supernet provides operating system-level enforcement of node compartmentalization in that an operating system-level component treats a Supernet node running on a device differently than it treats other processes on that device. This component (i.e., a security layer in a protocol stack) recognizes that a Supernet node is part of a Supernet, and therefore, it enforces that all communications to and from this node travel through the security infrastructure of the Supernet such that this node can communicate with other members of the Supernet and that non-members of the Supernet cannot access this node. Additionally, this operating system-level enforcement of node compartmentalization allows more than one Supernet node to run on the same machine, regardless of whether the nodes are from the same Supernet, and allows nodes of other networks to run on the same machine as a Supernet node.

### Extended Private Network Architecture

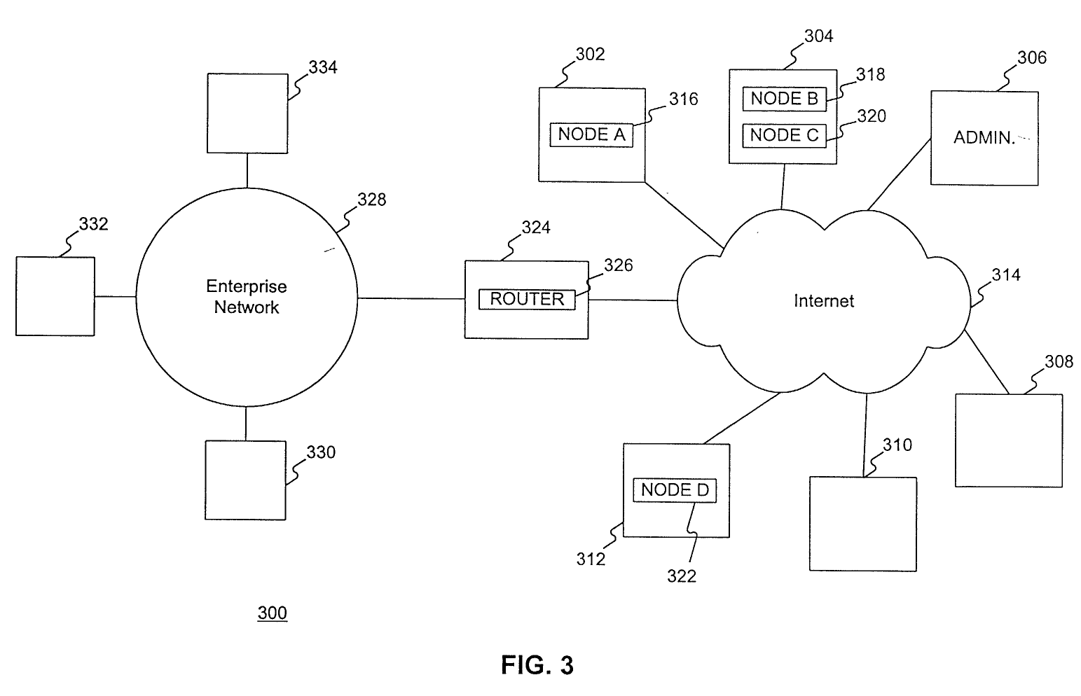

FIG. 3 is a diagram of an exemplary network environment in which the features and aspects of the present invention may be implemented. Network environment 300 includes a number of devices, such as computers 302-312 (including administrative machine 306), connected to a public network, such as Internet 314. Network environment 300 also includes a number of devices, such as computers 330-334, connected to a private network, such as enterprise network 328. A device, such as computer 324, is connected to both Internet 314 and enterprise network 328.

Nodes 316, 318, 320, and 322, and router node 326 together form a Supernet that may communicate by using the infrastructure of Internet 314. Router node 326 is also capable of communicating with computers 330-334 using enterprise network 328. Router node 326 enables devices that are part of enterprise network 328 to communicate with nodes from the Supernet. It is not necessary for those devices to be on a public infrastructure, such as Internet 314.

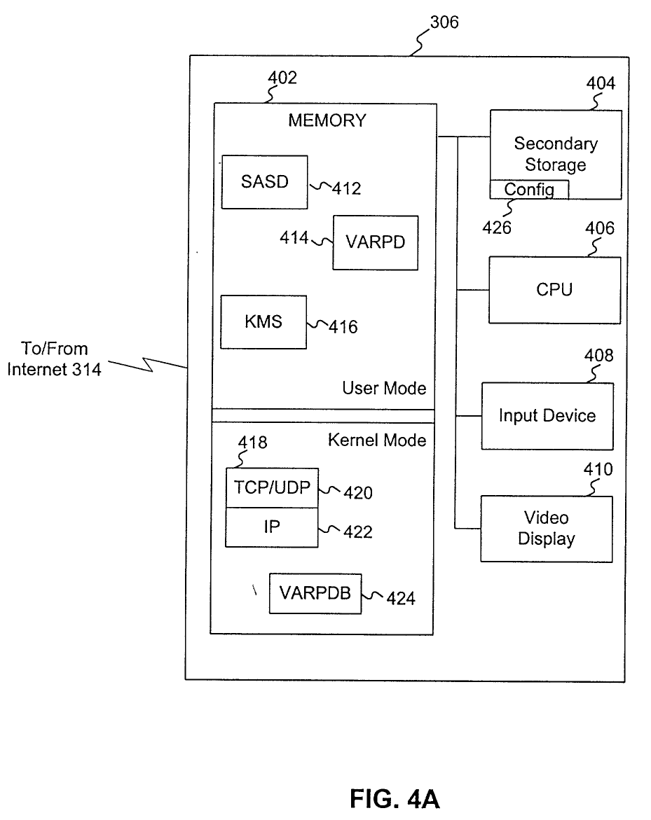

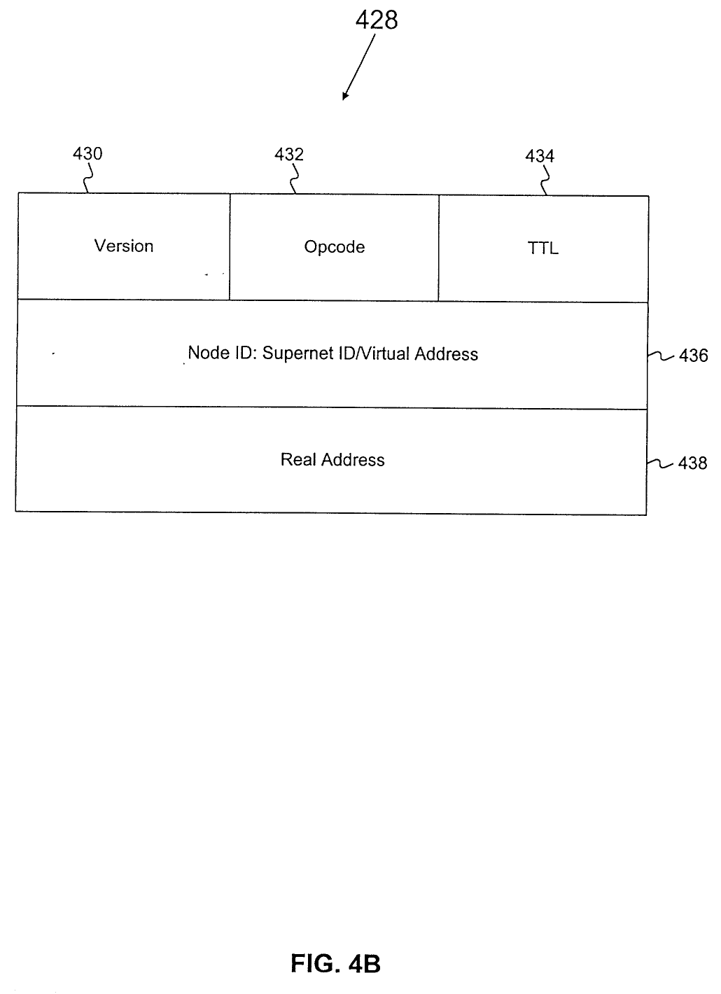

FIG. 4A is a diagram of an administrative machine in which the features and aspects of the present invention may be implemented. Administrative machine 306 includes a memory 402, secondary storage 404, a central processing unit (CPU) 406, an input device 408, and a video display 410. One skilled in the art will appreciate that administrative machine 306 may contain additional or different components.

Memory 402 of administrative machine 306 includes the SASD (Supernet Authentication Service Daemon) process 412, VARPD (Virtual Address Resolution Protocol Daemon) 414, and KMS (Key Management Server) 416 all running in user mode. That is, CPU 406 is capable of running in at least two modes: user mode and kernel mode. When CPU 406 executes programs running in user mode, it prevents them from directly manipulating the hardware components, such as video display 410. On the other hand, when CPU 512 executes programs running in kernel mode, it allows them to manipulate the hardware components. Memory 402 also contains a VARPDB (Virtual Address Resolution Protocol Database) 424 and a TCP/IP protocol stack 418 that are executed by CPU 406 running in kernel mode. TCP/IP (Transmission Control Protocol/Internet Protocol) protocol stack 418 contains a TCP/UDP (Transmission Control Protocol/User Datagram Protocol) layer 420 and an IP layer 422, both of which are standard layers well known to those of ordinary skill in the art. Secondary storage 404 contains a configuration file 426 that stores various configuration-related information (described below) for use by SASD 412.

SASD 412 represents a Supernet: there is one instance of an SASD per Supernet, and it both authenticates nodes and authorizes nodes to join the Supernet. VARPD 414 has an associated component, VARPDB 424, into which it stores mappings of the internal Supernet addresses, known as node IDs, to the network addresses recognized by the public-network infrastructure, known as the real addresses. The “node ID” may include the following: a Supernet ID (e.g., 0×123), reflecting a unique identifier of the Supernet, and a virtual address, comprising an IP address (e.g., 10.0.0.1). The “real address” is an IP address (e.g., 128.123.12.1) that is globally unique and meaningful to the public-network infrastructure. In a Supernet, one VARPD runs on each machine, and it may play two roles. First, a VARPD may act as a server by storing all address mappings for a particular Supernet into its associated VARPDB. Second, regardless of its role as a server or not, each VARPD assists in address translation for the nodes on its machine. In this role, the VARPD stores into its associated VARPDB the address mappings for its nodes, and if it needs a mapping that it does not have, it will contact the VARPD that acts as the server for the given Supernet to obtain it. In another embodiment, the functionality of the VARPD may be performed by the VARPDB.

FIG. 4B depicts an address mapping record 428 for use with methods and systems consistent with the present invention. Address mapping record 428 contains several fields, including version 430, opcode 432, TTL 434, node ID 436, and real address 438. Version field 430 of address mapping record 428 contains the version number of the VARPD program that a particular node is using. Opcode field 432 contains operation codes corresponding to the command that the local VARPD may issue to the server VARPD or vice versa. TTL field 434 of the address mapping record indicates the expiration time of a particular address mapping.

Referring back to FIG. 4A, KMS 416 performs key management by generating a new key every time a node joins a channel and by generating a new key every time a node leaves a channel. There is one KMS per channel in a Supernet.

To configure a Supernet, a system administrator creates a configuration file 426 that is used by SASD 412 when starting or reconfiguring a Supernet. This file may specify: (1) the Supernet name, (2) all of the channels in the Supernet, (3) the nodes that communicate over each channel, (4) the address of the KMS for each channel, (5) the address of the VARPD that acts as the server for the Supernet, (6) the user IDs of the users who are authorized to create Supernet nodes, (7) the authentication mechanism to use for each user of each channel, and (8) the encryption algorithm to use for each channel. Configuration file 426 may also be used to log router node 326 into a Supernet. Although the configuration information is described as being stored in a configuration file, one skilled in the art will appreciate that this information may be retrieved from other sources, such as databases or interactive configurations.

After the configuration file is created, it is used to start a Supernet. For example, when starting a Supernet, a system administrator first starts SASD 412, which reads the configuration information stored in the configuration file. Then, the administrator starts the VARPD on the administrator's machine, indicating that it will initially act as the server for the Supernet and also starts the KMS process. After this processing has completed, the Supernet is ready for nodes to join it.

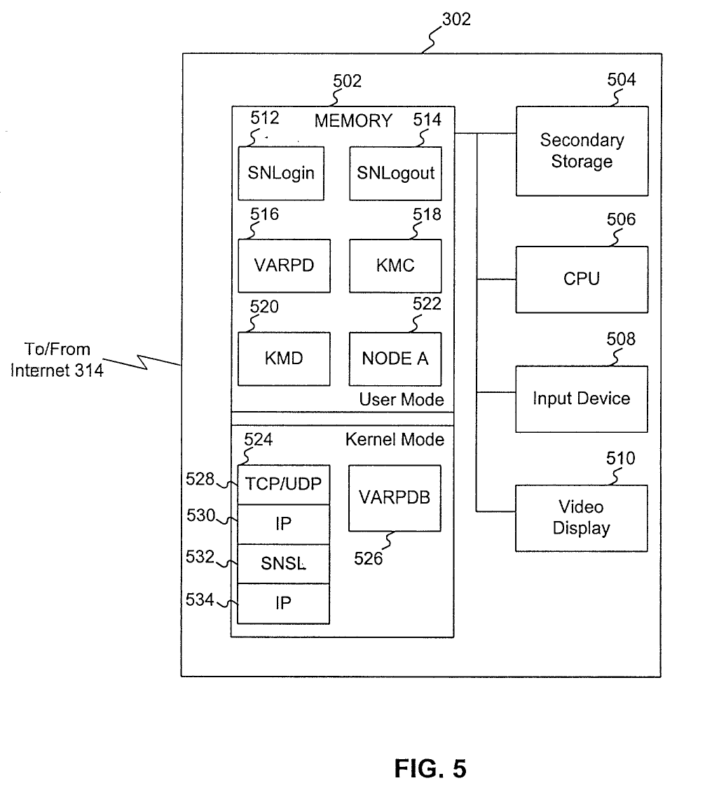

FIG. 5 is a diagram of computer 302 in greater detail, although the other computers 304 and 308-312 may contain similar components. Computer 302 includes a memory 502, secondary storage 504, a central processing unit (CPU) 506, an input device 508, and a video display 510. One skilled in the art will appreciate that computer 302 may contain additional or different components.

Memory 502 of computer 302 includes SNlogin script 512, SNlogout script 514, VARPD 516, KMC 518, KMD 520, and node A 522, all running in user mode. Memory 502 also includes TCP/IP protocol stack 524 and VARPDB 526 running in kernel mode.

SNlogin 512 is a script used for logging into a Supernet. Successfully executing this script results in a Unix shell from which programs (e.g., node A 522) can be started to run within the Supernet context, such that address translation and security encapsulation is performed transparently for them and all they can typically access is other nodes on the Supernet. Alternatively, a parameter may be passed into SNlogin 512 that indicates a particular process to be automatically run in a Supernet context. Once a program is running in a Supernet context, all programs spawned by that program also run in the Supernet context, unless explicitly stated otherwise. SNlogout 514 is a script used for logging out of a Supernet. Although both SNlogin 512 and SNlogout 514 are described as being scripts, one skilled in the art will appreciate that their processing may be performed by another form of software. The steps performed when a node logs into or out of a Supernet are more fully described in U.S. patent application Ser. No. 09/458,040, entitled “PRIVATE NETWORK USING A PUBLIC-NETWORK INFRASTRUCTURE,” filed Dec. 10, 1999, which has already been incorporated by reference.

VARPD 516 performs address translation between node IDs and real addresses. KMC 518 is the key management component for each node that receives updates whenever the key for a channel (“the channel key”) changes. There is one KMC per node per channel. KMD 520 receives requests from SNSL 532 of the TCP/IP protocol stack 524 when a packet is received and accesses the appropriate KMC for the destination node to retrieve the appropriate key to decrypt the packet. Node A 522 is a Supernet node running in a Supernet context.

TCP/IP protocol stack 524 includes a standard TCP/UDP layer 528, two standard IP layers (an inner IP layer 530 and an outer IP layer 534), and a Supernet security layer (SNSL) 532, acting as the conduit for all Supernet communications. To conserve memory, both inner IP layer 530 and outer IP layer 534 may share the same instance of the code of an IP layer. SNSL 532 performs security functionality as well as address translation. It also caches the most recently used channel keys for ten seconds. Thus, when a channel key is needed, SNSL 532 checks its cache first, and if it is not found, it requests KMD 520 to contact the appropriate KMC to retrieve the appropriate channel key. Two IP layers 530, 534 are used in the TCP/IP protocol stack 524 because both the internal addressing scheme and the external addressing scheme are IP-based. Thus, for example, when a packet is sent, inner IP layer 530 receives the packet from TCP/UDP layer 528 and processes the packet with its node ID address before passing it to the SNSL layer 532, which encrypts it, prepends the real source IP address and the real destination IP address, and then passes the encrypted packet to outer IP layer 534 for sending to the destination.

SNSL 532 utilizes VARPDB 526 to perform address translation. VARPDB stores all of the address mappings encountered thus far by SNSL 532. If SNSL 542 requests a mapping that VARPDB 526 does not have, VARPDB communicates with the VARPD 516 on the local machine to obtain the mapping. VARPD 516 will then contact the VARPD that acts as the server for this particular Supernet to obtain it.

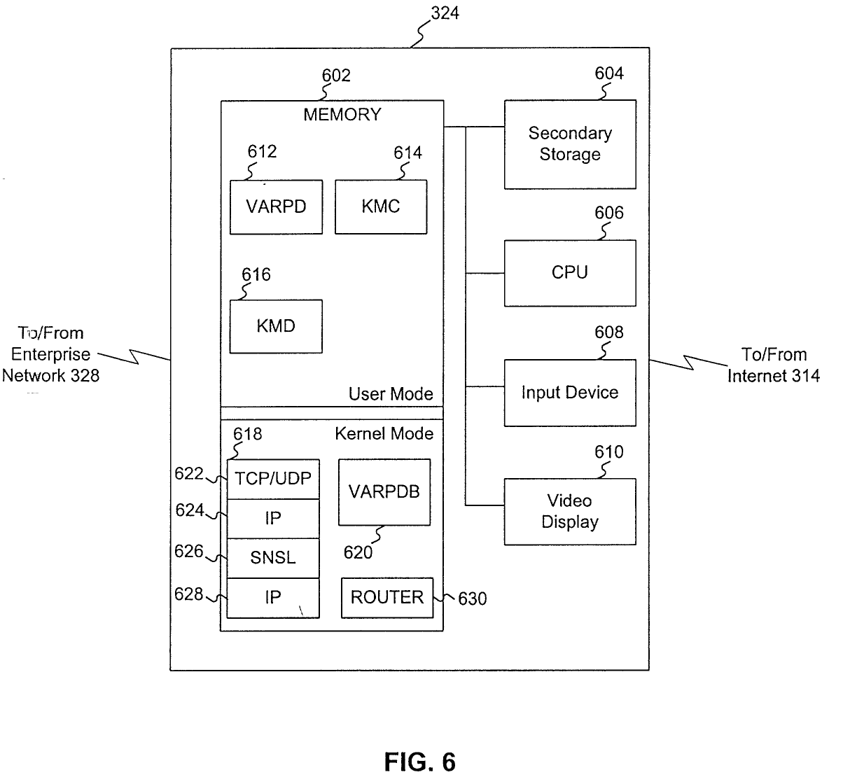

FIG. 6 is a diagram of computer 324 in greater detail. Computer 324 includes a memory 602, secondary storage 604, a central processing unit (CPU) 606, an input device 608, and a video display 610. One skilled in the art will appreciate that computer 324 may contain additional or different components.

Memory 602 of computer 324 includes VARPD 612, KMC 614, and KMD 616 all running in user mode. Memory 602 also includes TCP/IP protocol stack 618, VARPDB 620, and router node 630 running in kernel mode. VARPD 612, KMC 614, and KMD 616 operate in a similar manner to VARPD 516, KMC 518, and KMD 520 of computer 302, respectively. In one embodiment, VARPD 612 acts as the server for the Supernet. Memory 602 does not include a SNlogin script or a SNlogout script. TCP/IP protocol stack 618 (including its various layers, TCP/UDP layer 622, inner IP layer 624, outer IP layer 628, and SNSL layer 626), and VARPDB 620 operate in a similar manner to TCP/IP protocol stack 524 and VARPDB 526 of computer 302, respectively.

Router node 630 enables devices that are part of enterprise network 328 to communicate with nodes from the Supernet. Router node 630 is logged in to the Supernet and operates within the Supernet context. Because memory 602 does not include a SNlogin script or a SNlogout script, the administrative machine 306 logs router node 630 in and out of a Supernet using SASD 412 and configuration file 426. Alternatively, memory 602 may include a SNlogin script and a SNlogout script along with other nodes operating in the Supernet context.

When router node 630 receives a packet on its enterprise network interface, it checks to see if the destination address is logged into the Supernet. If so, then router node 630 proceeds to initiate a transfer of the packet to the appropriate Supernet node via the router node's public network interface. A packet sent from a Supernet node to a device on enterprise network 328 is directed to router node 630, which recognizes that the packet is destined for a device on enterprise network 328. Router node 630 then forwards the packet to the appropriate device.

Although aspects of the present invention are described as being stored in memory, one skilled in the art will appreciate that these aspects can also be stored on or read from other types of computer-readable media, such as secondary storage devices, like hard disks, floppy disks, or CD-ROM; a carrier wave, optical signal or digital signal from a network, such as the Internet; or other forms of RAM or ROM either currently known or later developed. Additionally, although a number of the software components are described as being located on the same machine, one skilled in the art will appreciate that these components may be distributed over a number of machines.

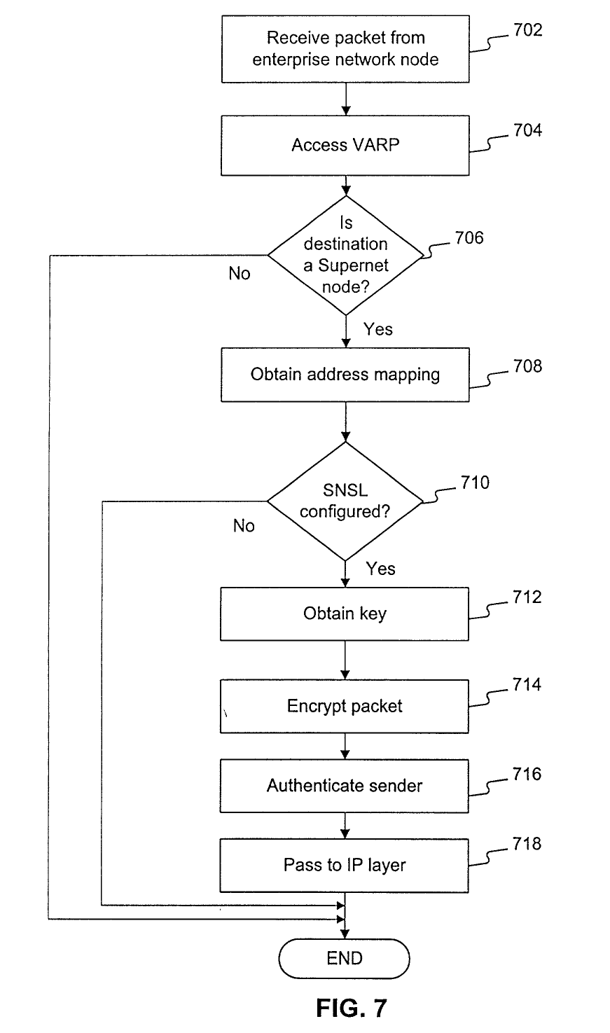

FIG. 7 is an exemplary flowchart of a method for sending a packet from an enterprise network to a Supernet in a manner consistent with the present invention. Although the steps of the flow chart are described in a particular order, one skilled in the art will appreciate that these steps may be performed in a different order. Additionally, although the SNSL layer is described as performing both authentication and encryption, this processing is policy driven such that either authentication, encryption, both, or neither may be performed.

First, router node 630 receives a packet originating from a node connected to enterprise network 328 (step 702). The packet includes a source node address, a destination node address, and data. Router node 630 accesses the VARPDB to obtain an address mapping corresponding to the destination node address (step 704). Next, VARPDB 620 determines whether the destination node address corresponds to a Supernet node (step 706). For example, VARPDB 620 determines whether it contains a mapping for the destination node address. Because VARPD 612 is designated as the server for this Supernet, no further check of a VARPD on another machine is necessary. In cases where VARPD 612 is not designated as the server, it accesses VARPD 612, which contacts the VARPD that acts as the server for the Supernet to attempt to find a mapping. Note that VARPDB 620 may also perform the functionality of VARPD 612 in addition to its previously described functionality.

If VARPDB 620 finds no mapping for the destination node address, then the destination node is not a Supernet node. Router node 630 may continue to attempt to find the destination node through other functions such as by looking at a table to see if the destination node address corresponds to an enterprise network node, or by forwarding the packet to another router in the enterprise network responsible for a different subnet. Router node 630 may also notify the source node that the packet is not deliverable.

If VARPDB 620 finds a mapping for the destination node address, then it retrieves the mapping and forwards it to router node 630 (step 708). In turn, router node 630 forwards the packet along with the address mapping to SNSL 626. After obtaining the address mapping, the SNSL layer determines whether it has been configured to communicate over the appropriate channel for this packet (step 710). If the SNSL has not been so configured, processing ends. Otherwise, SNSL obtains the channel key to be used for this channel (step 712). The SNSL maintains a local cache of keys and an indication of the channel to which each key is associated. Each channel key is time stamped to expire in ten seconds, although this time is configurable by the administrator.

If there is a key located in the cache for this channel, SNSL obtains the key. Otherwise, SNSL accesses KMD which then locates the appropriate channel key from the appropriate KMC. After obtaining the key, the SNSL layer encrypts the packet using the appropriate encryption algorithm and the key previously obtained (step 714). When encrypting the packet, the source node address (which is an enterprise network address), the destination node address (which is a node ID of the Supernet), and the data may be encrypted, but the source and destination real addresses are not, so that the real addresses can be used by the public network infrastructure to send the packet to its destination. The real source address included with the packet is the real IP address of router node 630. The real destination address included with the packet is the real IP address of the destination node, which was obtained in the address mapping.

After encrypting the packet, the SNSL layer authenticates the sender to verify that it is the bona fide sender and that the packet was not modified in transit (step 716). In this step, the SNSL layer uses the MD5 authentication protocol, although one skilled in the art will appreciate that other authentication protocols may be used. Next, the SNSL layer passes the packet to the IP layer where it is then sent to the destination node in accordance with known techniques associated with the IP protocol (step 718).

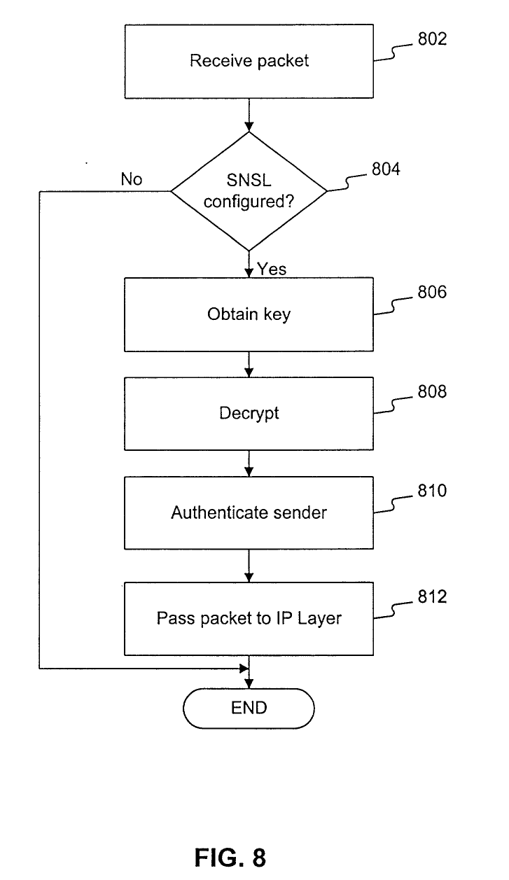

FIG. 8 is an exemplary flowchart of a method for receiving a packet by a Supernet node in a manner consistent with the present invention. Although the steps of the flow chart are described in a particular order, one skilled in the art will appreciate that these steps may be performed in a different order. Additionally, although the SNSL layer is described as performing both authentication and encryption, this processing is policy driven such that either authentication, encryption, both, or neither may be performed.

First, the SNSL layer of the receiving node receives a packet from the network (step 802). This packet contains a real source address and a real destination address that are not encrypted as well as a source node address, a destination node address, and data that are encrypted. In the case that the packet originated from an enterprise network node, the real source address is the real IP address of router node 630, the real destination address is the real IP address of the destination node, the source node address is the enterprise network address of the source, and the destination node address is the node ID of the Supernet node receiving the packet. In the case that the packet originated from a Supernet node, the real source address is the real IP address of the Supernet node that sent the packet, the real destination address is the real IP address of the destination node, the source node address is the node ID of the Supernet node that sent the packet, and the destination node address is the node ID of the Supernet node receiving the packet.

After receiving the packet, the SNSL layer determines whether it has been configured to communicate on this channel to the destination node (step 804). If SNSL has not been so configured, processing ends. Otherwise, the SNSL layer obtains the appropriate key as previously described (step 806). It then decrypts the packet using this key and the appropriate encryption algorithm (step 808). After decrypting the packet, the SNSL layer authenticates the sender and validates the integrity of the packet (step 810), and then it passes the packet to the inner IP layer for delivery to the appropriate node (step 812). Upon receiving the packet, the inner IP layer uses the destination node address to deliver the packet.

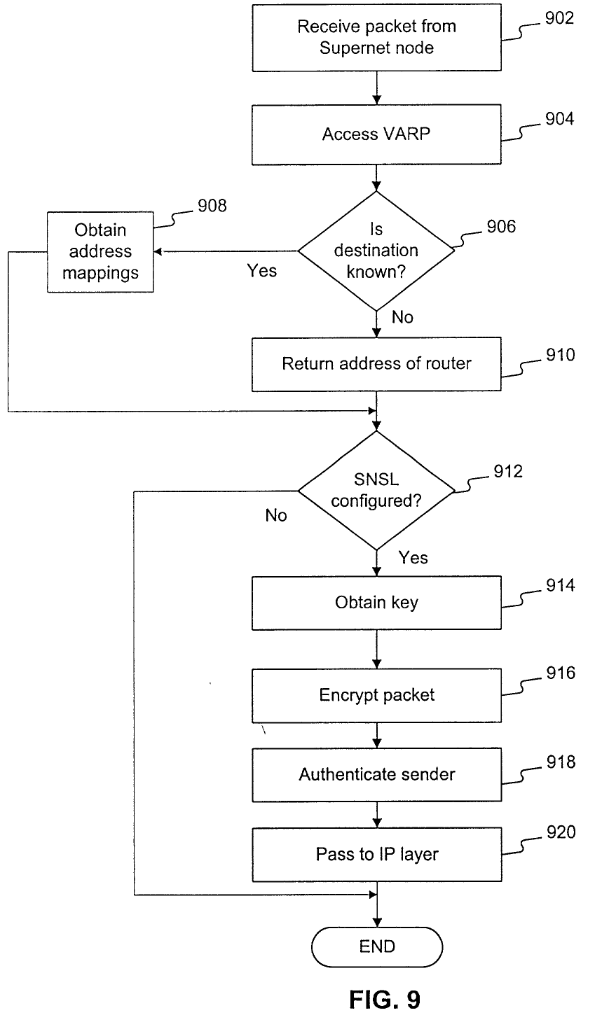

FIG. 9 is an exemplary flowchart of a method for sending a packet from a Supernet to an enterprise network in a manner consistent with the present invention. Although the steps of the flow chart are described in a particular order, one skilled in the art will appreciate that these steps may be performed in a different order. Additionally, although the SNSL layer is described as performing both authentication and encryption, this processing is policy driven such that either authentication, encryption, both, or neither may be performed.

The first step performed is for the SNSL layer to receive a packet originating from a Supernet node (e.g., a Supernet node at the same location as the SNSL layer) via the TCP/UDP layer and the inner IP layer (step 902). The packet includes a source node address, a destination node address, and data. The SNSL layer then accesses the VARPDB in an attempt to obtain address mappings corresponding to the source node address and the destination node address (step 904). VARPDB determines whether a mapping corresponding to the destination node address is known (step 906). For example, if mappings for the source and destination node addresses are not contained in the VARPDB because this is the first time a packet has been sent from this node or sent to this destination, the VARPDB accesses the local VARPD to obtain the mapping. When contacted, the VARPD on the local machine contacts the VARPD that acts as the server for the Supernet to obtain the appropriate address mapping. If the VARPD server has mappings for both the source and destination node addresses, or if the local VARPDB had the mappings, then the destination is a Supernet node and the SNSL obtains the mappings (step 908).

If neither the local VARPDB nor the VARPD server have a mapping for the destination address, then the local VARPDB returns the real IP address of router node 630 to the SNSL layer (step 910). The real IP address of router node 630 functions as the real destination address for the packet. Alternatively, if no mapping can be found for the destination node address a routing table for the enterprise network can be checked. This routing table may be associated with router node 630.

After obtaining the address mapping (including the real IP address of router node 630, if needed), the SNSL layer determines whether it has been configured to communicate over the appropriate channel for this packet (step 912). If the SNSL has not been so configured, processing ends. Otherwise, SNSL obtains the channel key to be used for this channel (step 914). The SNSL maintains a local cache of keys and an indication of the channel to which each key is associated. Each channel key is time stamped to expire in ten seconds, although this time is configurable by the administrator.

If there is a key located in the cache for this channel, SNSL obtains the key. Otherwise, SNSL accesses KMD which then locates the appropriate channel key from the appropriate KMC. After obtaining the key, the SNSL layer encrypts the packet using the appropriate encryption algorithm and the key previously obtained (step 916). When encrypting the packet, the source node address (which is a node ID of the Supernet), the destination node address (which is a node ID of the Supernet or an enterprise network address), and the data may be encrypted, but the source and destination real addresses are not, so that the real addresses can be used by the public network infrastructure to send the packet to its destination. The real source address included with the packet is the real IP address of the source node, which was obtained in the address mapping. The real destination address included with the packet is the real IP address of router node 630 or the real IP address of the destination node.

After encrypting the packet, the SNSL layer authenticates the sender to verify that it is the bona fide sender and that the packet was not modified in transit (step 918). In this step, the SNSL layer uses the MD5 authentication protocol, although one skilled in the art will appreciate that other authentication protocols may be used. Next, the SNSL layer passes the packet to the IP layer where it is then sent to the destination node (e.g., either a Supernet node or router node 630) in accordance with known techniques associated with the IP protocol (step 920).

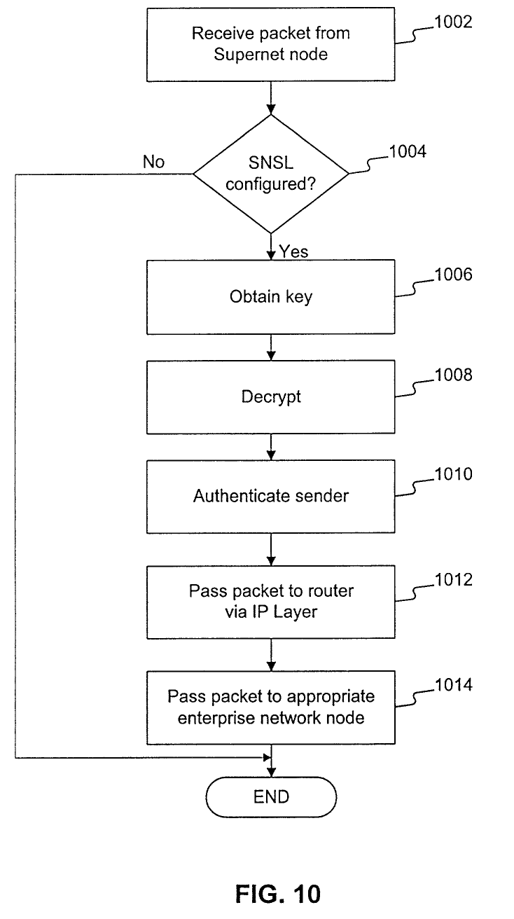

FIG. 10 is an exemplary flowchart of a method for receiving a packet for forwarding to an enterprise network in a manner consistent with the present invention. Although the steps of the flow chart are described in a particular order, one skilled in the art will appreciate that these steps may be performed in a different order. Additionally, although the SNSL layer is described as performing both authentication and encryption, this processing is policy driven such that either authentication, encryption, both, or neither may be performed.

First, the SNSL layer associated with router node 630 receives a packet from a Supernet node that is destined for an enterprise network node (step 1002). This packet contains a real source address and a real destination address that are not encrypted as well as a source node address, a destination node address, and data that are encrypted. Because the packet originated from a Supernet node, the real source address is the real IP address of the Supernet node that sent the packet, the real destination address is the real IP address of router node 630, the source node address is the node ID of the Supernet node that sent the packet, and the destination node address is the enterprise network address of the enterprise network node receiving the packet.

After receiving the packet, the SNSL layer determines whether it has been configured to communicate on this channel to the destination node (step 1004). If SNSL has not been so configured, processing ends. Otherwise, the SNSL layer obtains the appropriate key as previously described (step 1006). It then decrypts the packet using this key and the appropriate encryption algorithm (step 1008).

After decrypting the packet, the SNSL layer authenticates the sender and validates the integrity of the packet (step 1010), and then it passes the packet to the inner IP layer for delivery to router node 630 (step 1012). Upon receiving the packet, the inner IP layer uses the router node address to deliver the packet. Router node 630 then examines the packet and proceeds to initiate transfer of the packet to the appropriate enterprise network node (step 1014).

While the present invention has been described in connection with various embodiments, many modifications will be readily apparent to those skilled in the art. For example, while aspects of the invention have been described with reference to enterprise networks, the features of the invention may be adopted for other private networks such as another Supernet. Also, although the invention described only one private network (e.g., enterprise network) connected to one Supernet, the features of the invention may be expanded to connect any combination and number of private networks and Supernets. The invention, therefore, is not limited to the disclosure herein, but is intended to cover any adaptations or variations thereof.

What is claimed is:

1. A method for communicating between a first private network and a second private network configured from nodes in a public network, comprising:
receiving a packet from a source node in the first private network;
determining whether the packet is destined for the second private network; and
forwarding the packet to a destination node in the second private network based on the determination.

2. The method of claim 1, said forwarding comprising:
obtaining an address mapping corresponding to the destination node based on the determination; and
sending the packet to the destination node using the address mapping, the address mapping reflecting a relationship between an internal address for the destination node for use in communicating among nodes in the second private network and an external address for the destination node suitable for communicating over the public network.

3. The method of claim 2, said sending further comprising:
adding the external address to the packet.

4. The method of claim 2, said sending further comprising:
encrypting the packet.

5. The method of claim 2, said obtaining comprising:
accessing the address mapping based on a determination that the packet is destined for the second private network.

6. The method of claim 1, said determining comprising:
determining whether an address mapping exists for a destination address in the packet.

7. A method for communicating between a first private network and a second private network configured from nodes in a public network, comprising:
receiving a packet from a source node in the first private network;
determining whether the packet is destined for the second private network;
obtaining an address mapping corresponding to a destination node in the second private network based on the determination; and
sending the packet to the destination node using the address mapping, the address mapping reflecting a relationship between an internal address for the destination node for use in communicating among nodes in the second private network and an external address for the destination node suitable for communicating over the public network.

8. A method for communicating between a first private network and a second private network that uses a public network infrastructure, comprising:
receiving a packet from a source node in the second private network;
determining whether the packet is destined for the second private network; and
forwarding the packet to a destination node in the first private network based on the determination.

9. The method of claim 8, said forwarding comprising:
obtaining an address mapping corresponding to a router node based on the determination;
sending the packet to the router node using the address mapping, wherein the router node forwards the packet to the destination node based on an internal address in the packet for the destination node suitable for communicating among nodes in the first private network.

10. The method of claim 9, said sending further comprising:
adding, to the packet, an external address for the router node suitable for communicating over the public infrastructure.

11. The method of claim 9, said sending further comprising:
encrypting the packet.

12. The method of claim 9, said obtaining comprising:
accessing the address mapping based on a determination that the packet is not destined for the second private network.

13. The method of claim 8, said determining comprising:
determining whether an address mapping exists for a destination address in the packet.

14. A method for communicating between a first private network and a second private network that uses a public network infrastructure, comprising:
receiving a packet from a source node in the second private network;
determining whether the packet is destined for the second private network;
obtaining an address mapping corresponding to a router node based on the determination;
sending the packet to the router node using the address mapping, wherein the router node forwards the packet to a destination node in the first private network based on an internal address in the packet for the destination node suitable for communicating among nodes in the first private network.

15. An apparatus for communicating between a first private network and a second private network that uses a public network infrastructure, comprising:
a memory having program instructions; and
a processor responsive to the program instructions to receive a packet from a source node in the first private network, determine whether the packet is destined for the second private network, and forward the packet to a destination node in the second private network based on the determination.

16. An apparatus for communicating between a first private network and a second private network that uses a public network infrastructure, comprising:
a memory having program instructions; and
a processor responsive to the program instructions to receive a packet from a source node in the second private network, determine whether the packet is destined for the second private network, and forward the packet to a destination node in the first private network based on the determination.

17. A computer-readable medium containing instructions for performing a method for communicating between a first private network and a second private network that uses a public network infrastructure, the method comprising:
receiving a packet from a source node in the first private network;
determining whether the packet is destined for the second private network;
obtaining an address mapping corresponding to a destination node in the second private network based on the determination; and
sending the packet to the destination node using the address mapping, the address mapping reflecting a relationship between an internal address for the destination node for use in communicating among nodes in the second private network and an external address for the destination node suitable for communicating over the public infrastructure.

18. The computer-readable medium of claim 17, said sending further comprising:
adding the external address to the packet.

19. The computer-readable medium of claim 17, said sending further comprising:
encrypting the packet.

20. The computer-readable medium of claim 17, said obtaining comprising:
accessing the address mapping based on a determination that the packet is destined for the second private network.

21. The computer-readable medium of claim 17, said determining comprising:
determining whether an address mapping exists for a destination address in the packet.

22. A computer-readable medium containing instructions for performing a method for communicating between a first private network and a second private network that uses a public network infrastructure, the method comprising:
receiving a packet from a source node in the second private network;
determining whether the packet is destined for the second private network;
obtaining an address mapping corresponding to a router node based on the determination;
sending the packet to the router node using the address mapping, wherein the router node forwards the packet to a destination node in the first private network based on an internal address in the packet for the destination node suitable for communicating among nodes in the first private network.

23. The computer-readable medium of claim 22, said sending further comprising:
adding, to the packet, an external address for the router node suitable for communicating over the public infrastructure.

24. The computer-readable medium of claim 22, said sending further comprising:
encrypting the packet.

25. The computer-readable medium of claim 22, said obtaining comprising:
accessing the address mapping based on a determination that the packet is not destined for the second private network.

26. The computer-readable medium of claim 22, said determining comprising:
determining whether an address mapping exists for a destination address in the packet.

27. An apparatus for communicating between a first private network and a second private network configured from nodes in a public network infrastructure, comprising:
means for receiving a packet from a source node in the first private network;
means for determining whether the packet is destined for the second private network;
means for obtaining an address mapping corresponding to a destination node in the second private network based on the determination; and
means for sending the packet to the destination node using the address mapping, the address mapping reflecting a relationship between an internal address for the destination node for use in communicating among nodes in the second private network and an external address for the destination node suitable for communicating over the public infrastructure.

28. The apparatus of claim 27, said means for sending further comprising:
means for adding the external address to the packet.

29. The apparatus of claim 27, said means for sending further comprising:
means for encrypting the packet.

30. The apparatus of claim 27, said means for obtaining comprising:
means for accessing the address mapping based on a determination that the packet is destined for the second private network.

31. The apparatus of claim 27, said means for determining comprising:
means for determining whether an address mapping exists for a destination address in the packet.

32. An apparatus for communicating between a first private network and a second private network configured from nodes in a public network infrastructure, comprising:
means for receiving a packet from a source node in the second private network;
means for determining whether the packet is destined for the second private network;
means for obtaining an address mapping corresponding to a router node based on the determination;
means for sending the packet to the router node using the address mapping, wherein the router node forwards the packet to a destination node in the first private network based on an internal address in the packet for the destination node suitable for communicating among nodes in the first private network.

33. The apparatus of claim 32, said means for sending further comprising:
means for adding, to the packet, an external address for the router node suitable for communicating over the public infrastructure.

34. The apparatus of claim 32, said means for sending further comprising:
means for encrypting the packet.

35. The apparatus of claim 32, said means for obtaining comprising:
means for accessing the address mapping based on a determination that the packet is not destined for the second private network.

36. The apparatus of claim 32, said means for determining comprising:
means for determining whether an address mapping exists for a destination address in the packet.

37. A method for communicating between a first private network and a second private network configured from nodes in a public network, comprising:
receiving, at a router node, a first packet from a source node in the first private network, wherein the router node facilitates connection between the first private network and the second private network;
determining whether the first packet is destined for the second private network;
obtaining an address mapping corresponding to a destination node in the second private network based on the determination;
sending the packet to the destination node using the address mapping, the address mapping reflecting a relationship between an internal address for the destination node for use in communicating among nodes in the second private network and an external address for the destination node suitable for communicating over the public infrastructure;
receiving a second packet from a source node in the second private network;
determining whether the second packet is destined for the second private network;
obtaining an address mapping corresponding to the router node based on the determination that the second packet is not destined for the second private network; and
sending the packet to the router node using the address mapping corresponding to the router node, wherein the router node forwards the packet to a destination node in the first private network based on an internal address in the second packet for the destination node suitable for communicating among nodes in the first private network.
